(19) United States
(12) Patent Application Publication
(10) Pub. No.: US 2009/0066618 A1
(43) Pub. Date: Mar. 12, 2009

(54) METHOD AND SYSTEM FOR CONTROLLING A DISPLAY DEVICE

(75) Inventor: Pingfan Liu, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 12/206,367

(22) Filed: Sep. 8, 2008

(30) Foreign Application Priority Data
Sep. 10, 2007 (CN) 200710121587.1

(51) Int. Cl. G09G 3/32; G09G 3/34

(52) U.S. Cl. 345/83; 345/84

(57) ABSTRACT

The present invention discloses a method and system for controlling a display device is provided. The method for controlling a display device comprises steps of: S102, sampling contents of a current display frame stored in a storage module and to be displayed at the next moment to obtain image information of sampling points; S104, generating lighting control information according to the image information of the sampling points; and S106, controlling light sources located at peripheral regions of the display device according to the lighting control information to make them emit lights with different colors. The light sources located at the peripheral regions of the display device emit lights with different colors by a simple operation, as the displayed contents change.

### FIELD OF INVENTION

The present invention relates to a display device field, and particularly to a method and a system for controlling a display device.

### BACKGROUND OF THE INVENTION

The user's visual experiences will be improved, if there are a series of light sources for adaptively emitting lights with different colors according to changes of the screen colors when the user plays a computer game or enjoys a movie. It is needed to analyze the color changes of the contents displayed on the screen. In the image processing process, the algorithm is very important. If the algorithm is not selected suitably, on one hand the system load will be increased to affect the principle mission of the system; on the other hand the phenomenon may occurs that the control information based on the algorithm appears a hysteresis as compared with the changes of the screen.

Therefore, it is needed to design a suitable scheme to change the colors of the light sources located at the peripheral regions of the screen, at the same time to avoid occupying large resources of the processor by the image processing operation so as not to affect the major work of the system, and not to incur large hysteresis.

In the prior art, it is needed to form intermediate data with the frame interpolation algorithm to drive the light sources. This method is disadvantageous for the system that has a very large operation load. It is because that in the prior art, the existing image sampling is based on “color space”, and for the video formats such as MPEG2 and MPEG4 that utilize the Fourier transformation to carry out the coding, it is needed to be converted into “color space” and the color information of the image is then extracted. However, the conversion from the Fourier transformation to the color space requires occupying a great deal of operation time.

### SUMMARY OF THE INVENTION

For one or more aforementioned problems, the present invention provides a method and system for controlling a display device.

The method for controlling a display device according to the present invention comprises steps of: S102, sampling a current display frame stored in a storage module and to be displayed at the next moment, and obtaining image information of sampling points; S104, generating lighting control information according to the image information; and S106, controlling light sources located at peripheral regions according to the lighting control information to make them emit lights synchronizing with the display device's displaying of the current display frame.

Preferably, the step S104 comprises steps of: S1042, dividing the image information into groups by looking up a mapping table; S1044, accounting the number of the image information included in each group of said groups, and obtaining the major color of the current display frame according to accounting results; and S1046, generating the lighting control information according to the major color.

Preferably, the contents of the current display frame are uniformly sampled. The sampling of the current display frame is started after the current display frame is generated, and is finished before the current display frame is displayed. The image information is the color space information. The mapping table is a lookup table related to colors of images a color corresponding to a group which includes the maximum number of the image information is served as the major color of the current display frame.

The system for controlling a display device according to the present invention comprises: a storage module, for storing a current display frame to be displayed on the display device at the next moment; a sampling module, for sampling the contents of the current display frame to obtain image information of sampling points; and a lighting module, for generating lighting control information according to the image information and controlling light sources located at peripheral regions according to the lighting control information to make them emit lights synchronizing with the display device's displaying of the current display frame.

The lighting module comprises: a grouping unit, for dividing the image information into groups by looking up a mapping table; an accounting unit, for accounting the number of the image information included in each group of said groups, and obtaining the major color of the current display frame according to accounting results; and a controlling unit, for generating the lighting control information according to the major color and controlling the light sources located at the peripheral regions according to the lighting control information to make them emit lights.

Preferably, the sampling module uniformly samples the contents of the current display frame. The sampling module starts to sample the current display frame after the current display frame is generated and finishes the sampling before the current display frame is displayed. The image information is the color space information. The mapping table is a lookup table related to colors of images. The accounting unit uses a color corresponding to a group which includes the maximum number of the image information as the major color of the current display frame.

According to the present invention, the light sources located at the peripheral regions emit lights synchronizing with the display device's displaying of the current display frame by a simple operation, as the displayed contents change.

### BRIEF DESCRIPTION OF THE DRAWINGS

The above objects, advantages and features of the present invention will be apparent from the following detailed description on the preferred embodiments taken conjunction with the drawings in which:

FIG. 1 is a flowchart of the method for controlling a display device according to the embodiment of the present invention;

FIG. 2 is a schematic view of the process for forming a color lookup table according to the embodiment of the present invention;

FIG. 3 is a block diagram of the system for controlling a display device according to the embodiment of the present invention; and

FIG. 4 is the operating principle of the method and system for controlling a display device according to the present invention.

### DETAILED DESCRIPTION OF PREFERRED EMBODIMENTS

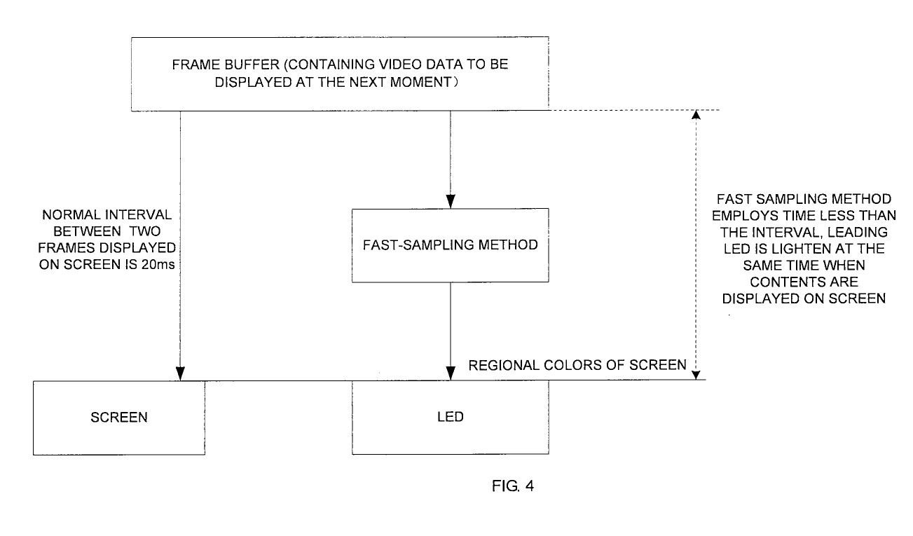

The objective of the present invention (as shown in FIG. 4) is to perform sampling based on the contents of the current display frame and to accomplish the sampling and controlling by fully employing the time spacing between the timing for forming the current display frame and the timing for sending the current display frame to the display device, thereby obtaining the effect of synchronization between the flicker of the light and the contents displayed on the display device. Preferably, the current display frame refers to the frame currently being in the system memory and to be sent to the display device at the next moment; the current display contents on the display device are “the contents of the previous frame”, and will be useless after being displayed. The embodiment of the present invention will be illustrated in detail.

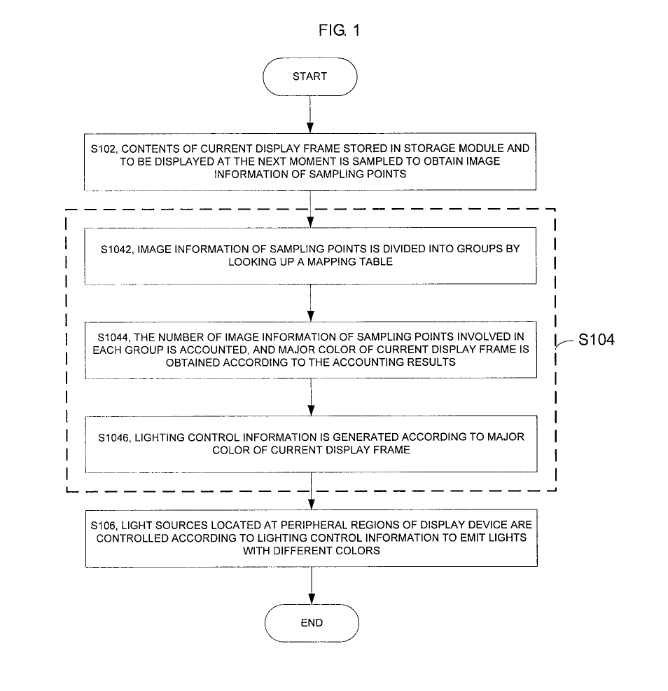

Referring to FIG. 1, a method for controlling the display device according to the embodiment of the present invention will be illustrated. As shown in FIG. 1, the method for controlling a display device comprises steps of: S102, sampling contents of a current display frame stored in a storage module and to be displayed at the next moment to obtain image information of sampling points; S104, generating lighting control information according to the image information of the sampling points; and S106, controlling light sources located at peripheral regions of the display device according to the lighting control information to make them emit lights with different colors

Wherein, the step S104 comprises steps of: S1042, dividing the image information of the sampling points into groups by looking up a mapping table; S1044, accounting the number of the image information of the sampling points involved in each group, and obtaining the major color of the current display frame according to the accounting results; and S1046, generating the lighting control information according to the major color of the current display frame.

Wherein, in the step S102, after the current display frame is generated and before the current display frame is displayed, the contents of the current display frame may be sampled uniformly. Thus it is ensured that the sampling points can reflect the color distribution of the sampling regions as accurately as possibly.

Wherein, the image information of the sampling points may be the color space information of the sampling points. The mapping table may be a lookup table concerning about the color of images. For example, sampling data containing precise information of colors (for example, RGB has 2²⁴ kinds of color combination scheme) may be classified into several colors with wide ranges (for example, red, yellow, blue, green, purple, and white . . . ). Then these kinds of colors will be accounted to make the color with the maximum possibility of occurrence serve as the major color of the current display frame.

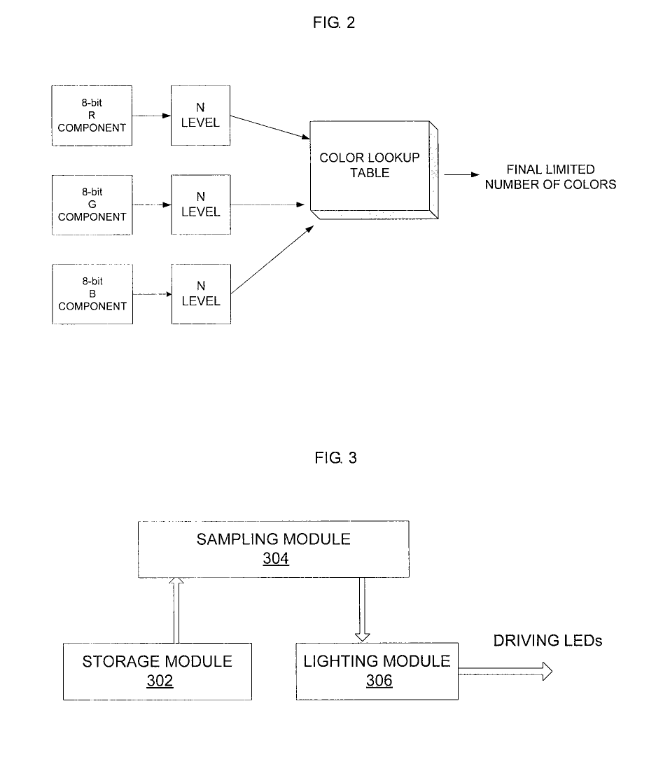

As shown in FIG. 2, the process for generating the color lookup table according to the embodiment of the present invention is as follows: each component of RGB has 8 bits, which means that each component has 256 levels, and the 256 levels are divided into N level; the 256³ combination will be reduced to N³ combination (usually it is sufficient by taking N into 8). The N³ mixed colors are selected in order to determine which one of colors of LED luminous tube to be selected is proximal to the mixed color. Then the combination of the mixed color maps to the one proximal color to be selected to form the color lookup table.

Referring to FIG. 3, the system for implementing the method for controlling the display device as shown in FIG. 1 according to the embodiment of the present invention will be illustrated. As shown in FIG. 3, the system for controlling the display device comprises: a storage module 302, for storing a current display frame to be displayed on the display device at the next moment; a sampling module 304, for sampling the contents of the current display frame to obtain image information of sampling points; a lighting module 306, for generating lighting control information according to the image information of the sampling points and controlling light sources located at peripheral regions of the display device according to the lighting control information to make them emit lights with different colors.

Wherein, the lighting module may comprise: a grouping unit, for dividing the image information of the sampling points into groups by looking up a mapping table; an accounting unit, for accounting the number of the image information of the sampling points involved in each group, and obtaining the major color of the current display frame according to the accounting results; and a controlling unit, for generating the lighting control information according to the major color of the current display frame and controlling the light sources located at the peripheral regions of the display device according to the lighting control information to make them emit lights with different colors.

Wherein, the sampling module may uniformly sample the contents of the current display frame after the current display frame is generated and before the current display frame is displayed. The image information of the sampling points may be the color space information of the sampling points. The mapping table may be a lookup table concerning about the color of images. The accounting unit may use the color corresponding to a group which involves the maximum number of the image information of the sampling points as the major color the current display frame.

The present embodiment is only one detailed embodiment of the present invention and does not intend to limit the scope of the present invention. Therefore, it is appreciated by those skilled in the art that various modifications and changes can be made. The modifications, equivalent substitutions and improvements will be interpreted as being contained in the scope defined in the following claims without departing from the spirit and scope of the present invention.

1. A method for controlling a display device, comprising steps of:
S102, sampling a current display frame stored in a storage module and to be displayed at the next moment, and obtaining image information of sampling points;
S104, generating lighting control information according to the image information; and
S106, controlling light sources located at peripheral regions according to the lighting control information to make them emit lights synchronizing with the display device's displaying of the current display frame.

2. The method for controlling a display device according to claim 1, wherein said step S104 comprises steps of:
S1042, dividing the image information into groups by looking up a mapping table;
S1044, accounting the number of the image information included in each group of said groups, and obtaining the major color of the current display frame according to accounting results; and
S1046, generating the lighting control information according to the major color.

3. The method for controlling a display device according to claim 1, wherein the current display frame is uniformly sampled.

4. The method for controlling a display device according to claim 3, wherein the sampling of the current display frame is started after the current display frame is generated, and is finished before the current display frame is displayed.

5. The method for controlling a display device according to claim 4, wherein said image information is the color space information.

6. The method for controlling a display device according to claim 5, wherein said mapping table is a lookup table related to colors of images.

7. The method for controlling a display device according to claim 6, wherein a color corresponding to a group which includes the maximum number of the image information is served as the major color of said current display frame.

8. A system for controlling a display device, comprising:
a storage module, for storing a current display frame to be displayed on the display device at the next moment;
a sampling module, for sampling the contents of the current display frame to obtain image information of sampling points; and
a lighting module, for generating lighting control information according to the image information and controlling light sources located at peripheral regions according to the lighting control information to make them emit lights synchronizing with the display device's displaying of the current display frame.

9. The system for controlling a display device according to claim 8, wherein said lighting module comprises:
a grouping unit, for dividing the image information into groups by looking up a mapping table;
an accounting unit, for accounting the number of the image information included in each group of said groups, and obtaining the major color of the current display frame according to accounting results; and
a controlling unit, for generating the lighting control information according to the major color and controlling the light sources located at the peripheral regions according to the lighting control information to make them emit lights.

10. The system for controlling a display device according to claim 8, wherein said sampling module uniformly samples the current display frame.

11. The system for controlling a display device according to claim 10, wherein said sampling module starts to sample the current display frame after said current display frame is generated and finishes the sampling before said current display frame is displayed.

12. The system for controlling a display device according to claim 11, wherein said image information is the color space information.

13. The system for controlling a display device according to claim 12, wherein said mapping table is a lookup table related to colors of images.

14. The system for controlling a display device according to claim 13, wherein said accounting unit uses a color corresponding to a group which includes the maximum number of the image information as the major color of the current display frame.

15. The system for controlling a display device according to claim 9, wherein said sampling module uniformly samples the current display frame.
